(19) United States
(12) Patent Application Publication
(10) Pub. No.: US 2024/0403654 A1
(43) Pub. Date: Dec. 5, 2024

(54) FEDERATED LEARNING PARTICIPANT SELECTION THROUGH LABEL DISTRIBUTION CLUSTERING

(71) Applicant: International Business Machines Corporation, Armonk, NY (US)

(72) Inventors: Jayaram Kallapalayam Radhakrishnan, Pleasantville, NY (US); Rahul Atul Bhope, Irvine, CA (US); Ashish Verma, Nanuet, NY (US); Gegi Thomas, Danbury, CT (US)

(21) Appl. No.: 18/326,204

(22) Filed: May 31, 2023

(51) Int. Cl. G06N 3/098

(52) U.S. Cl. CPC G06N 3/098

(57) ABSTRACT

Systems and techniques that facilitate participant selection in federated learning are provided. For example, one or more embodiments described herein can comprise a system, which can comprise a memory that can store computer executable components. The system can also comprise a processor, operably coupled to the memory that can execute the computer executable components stored in memory. The computer executable components can comprise a clustering component that clusters one or more participants in a federated learning system based on distributions of data classification labels for data sets of the one or more participants into one or more clusters of participants; and a selection component that selects participants equitably from across the one or more clusters of participants for a round of federated learning.

### BACKGROUND

The subject disclosure relates to federated learning, and more specifically, to participant label distribution clustering in federated learning.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate clustering of federated learning participants based on label distribution are provided.

According to an embodiment, a system can comprise a processor that executes computer executable components stored in memory. The computer executable components comprise a clustering component that clusters one or more participants in a federated learning system based on distributions of data classification labels for data sets of the one or more participants into one or more clusters of participants; and a selection component that selects participants equitably from across the one or more clusters of participants for a round of federated learning.

In some embodiments, the computer executable components can further comprise a communication component that that establishes one or more secure communication channels between the one or more participants and a trusted execution environment.

According to another embodiment, a computer-implemented method can comprise clustering, by a system operatively coupled to a processor, one or more participants in a federated learning system based on distributions of data classification labels for data sets of the one or more participants into one or more clusters of participants; and selecting, by the system, participants equitably from across the one or more clusters of participants for a round of federated learning.

In some embodiments, the above computer-implemented method can further comprise establishing, by the system, one or more secure communication channels between the one or more participants and a trusted execution environment.

According to another embodiment, a computer program product comprising a computer readable storage medium having program instructions embodied therewith, the program instructions executable by a processor to cause the processor to cluster one or more participants in a federated learning system based on distributions of data classification labels for data sets of the one or more participants into one or more clusters of participants; and select participants equitably from across the one or more clusters of participants for a round of federated learning.

In some embodiments, the program instructions are further executable by the processor to cause the processor to establish one or more secure communication channels between the one or more participants and a trusted execution environment.

### DESCRIPTION OF THE DRAWINGS

FIG. 1 illustrates block diagram of an example, non-limiting system that can facilitate participant selection in federated learning in accordance with one or more embodiments described herein.

FIG. 2 illustrates a block diagram of a trusted execution environment that can facilitate participant clustering and selection in accordance with one or more embodiments described herein.

FIG. 3 illustrates a flow diagram of an example, non-limiting participant selection process in accordance with one or more embodiments described herein.

FIG. 4 illustrates a flow diagram of an example, non-limiting computer-implemented method that can facilitate participant selection in accordance with one or more embodiments described herein.

FIG. 5 illustrates a flow diagram of an example, non-limiting computer-implemented method that can facilitate participant selection in accordance with one or more embodiments described herein.

FIG. 6 illustrates a flow diagram of an example, non-limiting computer-implemented method that can facilitate participant selection in accordance with one or more embodiments described herein.

FIG. 7 illustrates a chart comparing the performance of participant selections methods described herein with randomized participant selection in accordance with one or more embodiments described herein.

FIG. 8 illustrates a chart comparing the performance of participant selections methods described herein with randomized participant selection in accordance with one or more embodiments described herein.

FIG. 9 illustrates a chart comparing the performance of participant selections methods described herein with randomized participant selection in accordance with one or more embodiments described herein.

FIGS. 10-13 illustrates graphs comparing the performance of participant selection methods based on clustering as described herein with randomized participant selection methods in accordance with one or more embodiments described herein.

FIG. 14 illustrates an example, non-limiting environment for the execution of at least some of the computer code in accordance with one or more embodiments described herein.

FIG. 15 illustrates a block diagram of an example, non-limiting operating environment in which one or more embodiments described herein can be facilitated.

Appendix A is a detailed paper describing various embodiments and is to be considered part of this patent specification.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

Federated learning (FL) is a setting for machine learning where several participants (e.g., mobile devices, organizations, entities, etc.) work together to train a global or centralized machine learning model while data of the participants is not shared and kept decentralized. For example, an aggregator can distribute a machine learning model to one or more participants, wherein the participants train a version of the machine learning model locally using data unique to each participant. The aggregator then aggregates the trained local versions or outputs from the trained local versions, such as embeddings, from the trained local versions to update a centralized version of the machine learning model. The updated centralized model can then be distributed to the participants for additional rounds of federated learning. Achieving convergence and high accuracy of the machine learning model is challenging in large-scale FL training due to unreliable participant availability, communication constraints, and because different participants can have different types and distributions of data (e.g., different data labels and distributions of data). Accordingly, for each round of FL training, each participant trains at its convenience or feasibility. This may be when devices are connected to power, in the case of mobile phones, tablets and laptops; when local resource utilization from other computations is low or when there are no pending jobs with higher priority. Due to this intermittent nature, FL system often select a subset of participants to aggregate at each round. FL systems often use randomization to select participants for a given round of federated learning, which can involve only a fraction of total participants. Consequently, this often increases the time taken for the aggregator to converge as in real-world data sets, data distribution among participants is not identically and independently distributed (IID). Accordingly, intermittent availability of participants combined with the non-IID nature of participant data sets can greatly increase model convergence time, negatively impact model accuracy, and increase communication cycles and/or bandwidth usage between the aggregator and participants. Accordingly, participant selection is a key problem in FL.

In view of the problems discussed above, in relation to participant selection in federated learning, the present disclosure can be implemented to produce a solution to one or more of these problems by clustering, by a system operatively coupled to a processor, one or more participants in a federated learning system based on distributions of data classification labels for data sets of the one or more participants into one or more clusters of participants, and selecting, by the system, participants equitably from across the one or more clusters of participants for a round of federated learning. By clustering participants based on label distributions of the participant data sets, distributions of participants with similar data sets are created, enabling participant selection that allows for better representation of participant data as a whole and greater variety of data labels. Further, by selecting a participant from each cluster of participants, each cluster is equally represented during training, thus avoiding the class/label/type imbalance issues of non-IID training data.

In a further embodiment, underrepresented participants from across the one or more clusters of participants can be selected for a second or additional round of federated learning. By selecting participants that have not been selected in previous rounds, a greater number of participants can be included early-on in the federated learning, thus reducing model convergence time, communication costs, and improving accuracy of the model when compared to random selection which is used in a wide variety of existing federated learning systems.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

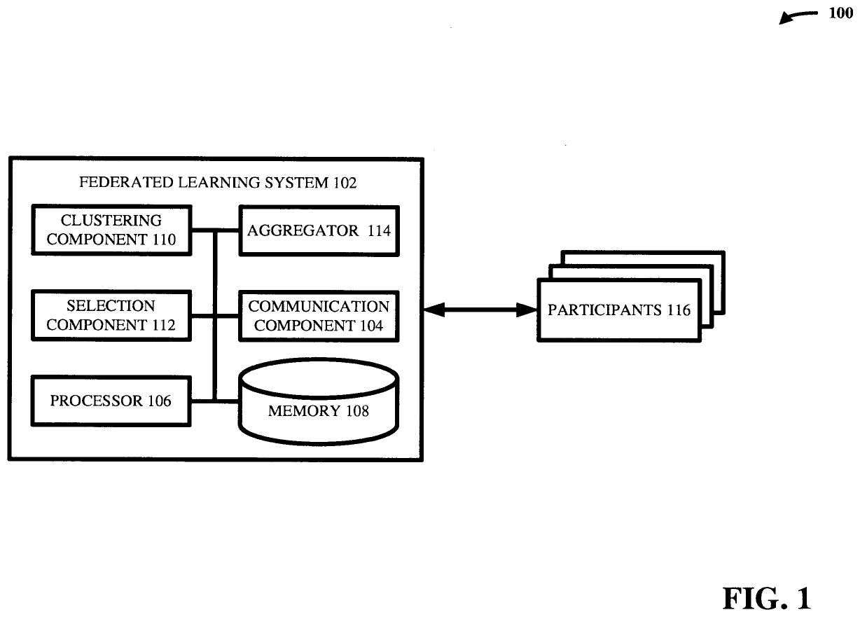

FIG. 1 illustrates block diagram of an example, non-limiting system 100 that can facilitate participant selection in federated learning. Repetitive description of like elements employed in other embodiments described herein is omitted for sake of brevity. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise aggregator 114, communication component 104, clustering component 110, selection component 112, processor 106 and memory 108.

In various embodiments, federated learning system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the federated learning system 102 (e.g., aggregator 114, communication component 104, clustering component 110, and/or selection component 112) to perform one or more acts. In various embodiments, the memory 108 can store computer-executable components (e.g., aggregator 114, communication component 104, clustering component 110, and/or selection component 112), the processor 106 can execute the computer-executable components. In various embodiments, the aggregator 114 can be stored on a first server and one or more participants 116 can be stored on one or more alternative servers.

According to some embodiments, a machine learning model can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning model can employ principles of probabilistic and decision theoretic inference to determine one or more responses based on information retained in a knowledge source database. Additionally, or alternatively, aggregator 114 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

The various aspects (e.g., in connection with automatic classification and/or prediction of data) can employ various artificial intelligence-based schemes for carrying out various aspects thereof. For example, a process for evaluating one or more parameters of a target entity can be utilized to predict one or more responses, predictions, and/or classifications, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to, whether to select a first classification instead of a second classification from a plurality of possible classifications. Another example includes whether, in the absence of specific information about the target entity, data from another target entity or a group of target entities can be utilized (which can impact a confidence score). For example, attributes can be identification of a target entity based on historical information and the classes can be related answers, related conditions, and/or related diagnoses.

A deep neural network (DNN) is an example of a classifier that can be employed. The DNN operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, DNN's can be configured through a learning phase or a training phase within a classifier constructor and feature selection module. Thus, a classifier(s) can be used to automatically learn and perform a number of functions, including but not limited to, determining according to a defined criteria a relevant response, prediction, and/or classification based on a given set of characteristics of a target entity. Further to this example, the relevant responses, predictions, and/or classifications can be selected from a multitude of responses, predictions, and/or classifications. Another function can include determining one or more responses, predictions, and/or classifications in view of information known about the target entity and assigning confidence scores to the responses. The criteria can include, but is not limited to, historical information, similar entities, similar subject matter, and so forth.

Additionally or alternatively, an embodiment scheme (e.g., a rule, a policy, and so on) can be applied to control and/or regulate an embodiment of automatic selection and/or determination of responses, predictions, and/or classifications before, during, and/or after a computerized assessment process. In some embodiments, based on a defined criterion, the rules-based embodiment can automatically and/or dynamically interpret how to respond to a particular question and/or one or more questions. In response thereto, the rule-based embodiment can automatically interpret and carry out functions associated with formatting the response or one or more responses based on an electronic format for receipt of the responses by employing a defined and/or programmed rule(s) based on any desired criteria.

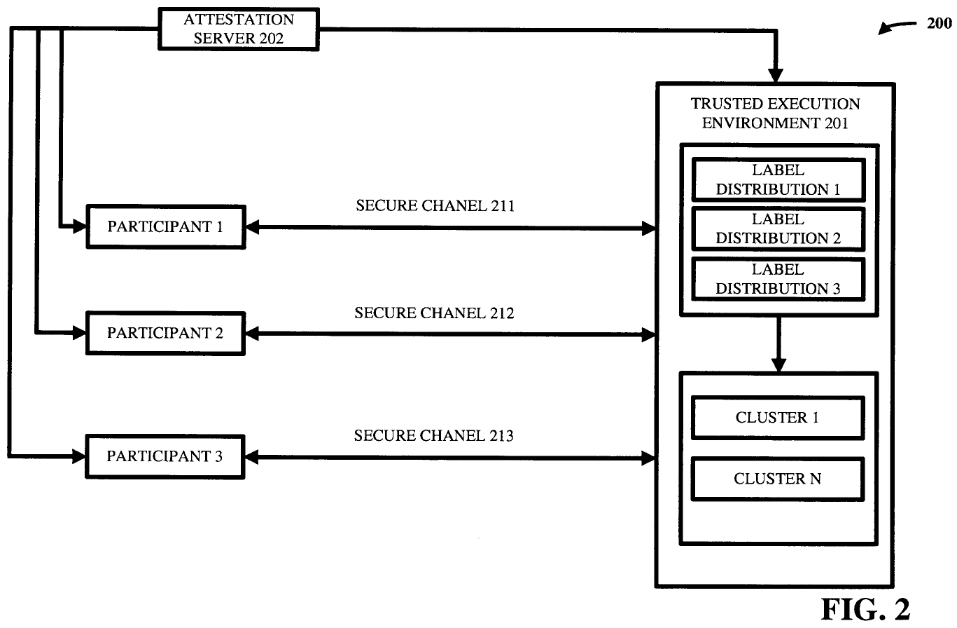

In one or more embodiments, communication component 104 can receive one or distributions of data classification labels for one or more data sets from one or more federated learning participants 116. For example, communication component 104 can receive a first label distribution for a first data set from a first participant of participants 116, and a second label distribution for a second data set from a second participant of participants 116. It should be appreciated that use of any number of data sets, label distributions from the data sets and any number of participants is envisioned. In an embodiment, communication component 104 can receive the one or more label distributions from the one or more participants over secure communications channels. For example, secure channels with cryptographic protocols can be utilized to ensure sensitive data is protected in transit from participants 116 to communication component 104. In an embodiment, the secure communications channels can utilize a protocol such as Transport Layer Security (TLS) or other suitable cryptographic or encryption methods. In an embodiment, a different secure channel can be utilized for each participant of participants 116. For example, communication component 104 can operate a first secure channel to communicate with a first participant and a second secure channel to communicate with a second participant. As described in greater detail below in regard to FIG. 2, communication component 104 can operate an attestation server to facilitate verification of the integrity of data and computation with participants 116.

In one or more embodiments, clustering component 110 can cluster the one or more participants based on label distributions for the one or more data sets into one or more clusters. For example, each participant of participants 116 can measure distributions of data classification labels from the participant's i dataset ldᵢ={L₁, L₂, . . . , L_{g}} where Lᵢ is the number of data points for the jth label present on the participant and g is the number of labels in the dataset that a model is trained on. The label distributions from each participant can be stacked by clustering component 110 to form a set LD={ld₁, ld₂, . . . , ld_{N}}, where N is the number of participants in the federated learning. Clustering component 110 can then cluster participants with similar label distributions and group them into clusters, each representing a unique label distribution. For examples, multiple hospitals that specialize in research may be clustered into a first cluster, as their label distributions may be similar, while multiple hospitals that specialize in pediatric care may be clustered into a second cluster, as their label distributions may be similar. This can enable uniform cluster representation during federated learning. In an embodiment, clustering component 110 can utilize K-Means clustering to generate the clusters. K-Means clustering has a time complexity of O(nsl*d), where n is the number of data points, s is the number of clusters, I is the number of iterations or rounds, and d is the number of dimensions. In an embodiment, other clustering techniques such as DBSCAN or OPTICS can be utilized to identity clusters of arbitrary shape and size. To establish if a data point is a member of a cluster of not, a density threshold can be applied. In some embodiments, a Davies Bouldin Index can be utilized to determine the number of clusters to produce.

In an embodiment, selection component 112 can select participants equitably from across the one or more clusters of participants for a round of federated learning. For example, given a set of clusters of participants C, from clustering component 110, selection component 112 can select participants for a round of federated learning by choosing one participant at a time from each cluster in a round-robin manner until the number of parties utilized for the round, Nr, is reached. This ensures that participants for a round of federated learning, Nr, is spread among as many clusters as possible, thereby increasing the number of different label distributions utilized in the federated learning round. In an embodiment, Nr can be a multiple of the number of clusters |C| since Nr can then be evenly split among the number of available clusters (|C|), ensuring even representation from each cluster. In an embodiment, the same number of participants can be selected across multiple rounds to further promote uniformity. Selection component 112 can also keep track of the number of times a participant was selected to ensure that all participants in a cluster are selected at least once. Selection component 112 can additionally track the number of times a cluster is selected. Accordingly, in the event that number of participants per round is less than the number of clusters, clusters and/or participants can still be evenly represented across multiple rounds. Aggregator 114 can then utilize the selected participants for the round of federated learning. For example, aggregator 114 can receive local versions of the machine learning model from the selected participants of participants 116 and aggregate the received local versions to create an updated machine learning model, which can then be distributed to all participants, regardless of whether the participant was selected at that round. In various embodiments, aggregator 114 can receive various types of data from the selected participants to aggregate. For example, in some embodiments, aggregator 114 can receive machine learning outputs or embeddings from the selected participants of participants 116. In additional rounds of federated learning, selection component 112 can select participants that were underrepresented (e.g., unselected or selected fewer times than other participants) in previous rounds of federated learning to ensure better participation of participants 116 in the federated learning process. In various embodiments, the rounds of federated learning can continue until all participants are selected at least a defined number of times, all clusters have been selected at least a defined number of times, a defined number of rounds has been met, a defined amount of training time has elapsed, the machine learning model has reached convergence, the machine learning model has reached a defined level of accuracy, or another condition has been met.

FIG. 2 illustrates a block diagram of a trusted execution environment (TEE) 201 that can facilitate participant clustering and selection in accordance with one or more embodiments described herein. Repetitive description of like elements employed in other embodiments described herein is omitted for sake of brevity.

In federated learning, participants often consider label distributions to be private, as label distributions can reveal the kinds of data logged by a participant and the prevalence of said data. Despite the benefits of clustering as described above in relation to FIG. 1, some participants may be unwilling to share this information with federated learning system 102. Accordingly, a trusted execution environment (TEE), such as TEE 201, can be utilized to protect participant label distributions. A TEE is a secure area of a main processor that provides features for isolated execution that guarantees the integrity of applications executing within, along with the confidentiality of their data assets. TEEs establish an isolated execution environment that runs in parallel with standard operating systems. Accordingly, TEEs offer protection for sensitive data and code against attacks from potentially compromised native operating systems, such as those can occur with aggregators. In a TEE, only trusted applications running in the TEE have access to the full power of a device's main processor, peripherals, and memory. While hardware installations can protect data from user-installed apps running on a main operating system, software and cryptographic isolation inside a TEE protect trusted applications contained within from one and other. As shown in FIG. 2, communication component 104 can establish secure channels between participants and TEE 201. For example, secure channel 211 can be established between participant 1 and TEE 201, secure channel 212 can be established between participant 2 and TEE 201, and secure channel 213 can be established between participant 3 and TEE 201. Further, attestation server 202 can provide authentication between the participants and TEE 201 to provide assurances to the participants that their label distributions are protected.

The participants can then transmit their respective distributions of data classification labels (e.g., label distribution 1, label distribution 2 and label distribution 3) via the respective secure channels to TEE 201. TEE 201 can then store the label distributions, in order to protect the label distributions from unauthorized access. In an embodiment, clustering component 110 and selection component 112 can operate within TEE 201, thereby giving clustering component 110 access to the label distributions, offering protected storage of the clusters (e.g., cluster 1 and cluster N) in TEE 201, and enabling selection of participants from the clusters by selection component 112. In an embodiment, once a round or series of rounds of federated learning is complete, TEE 201 can delete the stored label distributions and clusters and deactivate the secure channels to prevent unauthorized access of the privileged data.

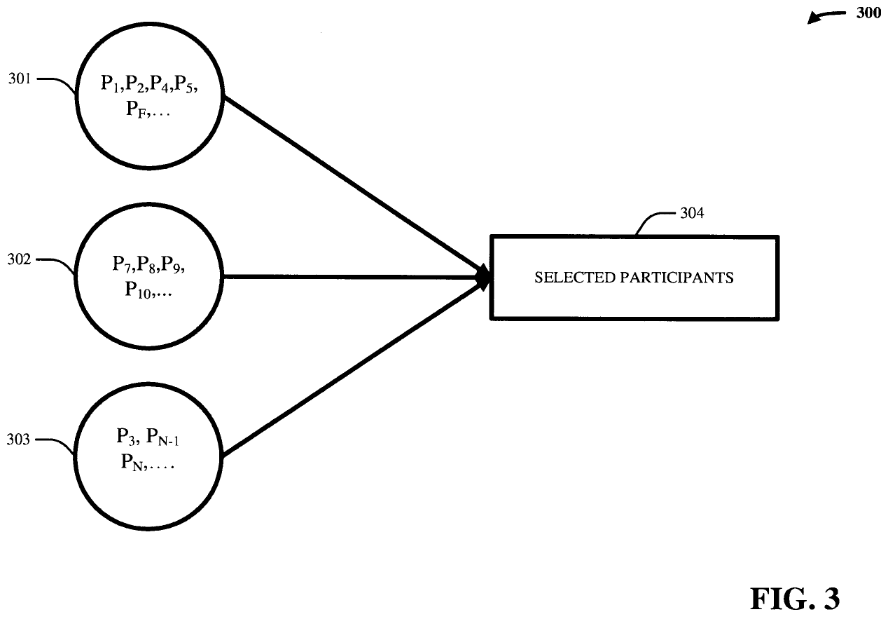

FIG. 3 illustrates a flow diagram 300 of an example, non-limiting participant selection process in accordance with one or more embodiments described herein. Repetitive description of like elements employed in other embodiments described herein is omitted for sake of brevity.

As shown participants have been clustered into cluster 301, 302 and 303 by clustering component 110 as described above in detail in reference to FIG. 1. Selection component 112 can then select participants from clusters 301, 302 and 303. For example, if the round of training calls for three participants, selection component 112 can select one participant from cluster 301, one participant from cluster 302, and one participant from cluster 303, to generate selected participants 304 which can be used by aggregator 114. As described above in reference to FIG. 1, selection component 112 can keep track of which participants have been selected. For example, if selection component 112 selected P₁ from cluster 301 on a first training round, selection component 112 can select a participant other than P₁ from cluster 301 on one or more subsequent training rounds until all participants from cluster 301 have been selected an equal number of times, or until the federated learning process is complete. In another example, if the round of training calls for two participants, selection component 112 can keep track of which clusters the two participants are selected from. In a subsequent round of federated learning, selection component 112 can ensure a participant is selected from the cluster that was not included in the previous round of federated learning. In this manner, selection component 112 can ensure that participants are selected both evenly from clusters 301, 302 and 303 and selected evenly within said clusters, thereby improving participation of the participants and model convergence in the specific federated learning job.

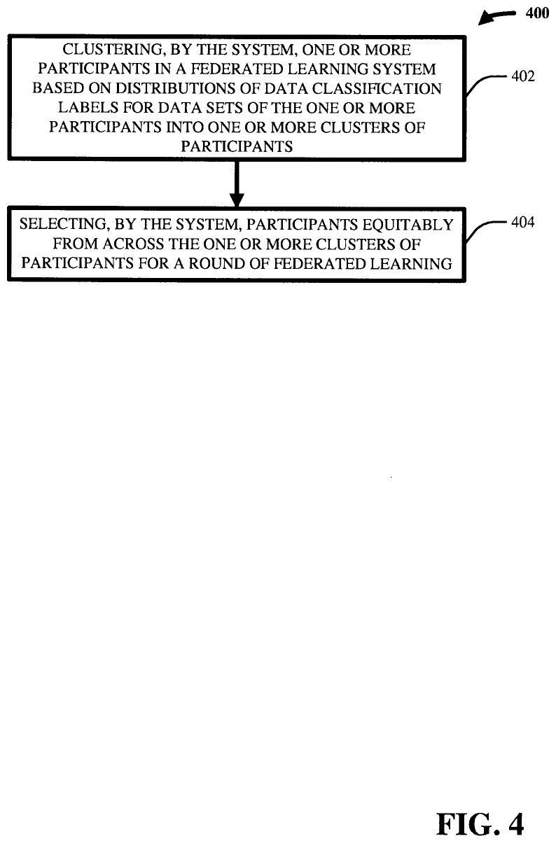

FIG. 4 illustrates a flow diagram of an example, non-limiting computer-implemented method 400 that can facilitate participant selection in accordance with one or more embodiments described herein. Repetitive description of like elements employed in other embodiments described herein is omitted for sake of brevity.

At 402, method 400 can comprise clustering, by a system (e.g., federated learning system 102 and/or clustering component 110) operatively coupled to a processor (e.g., processor 106) one or more participants in a federated learning system based on distributions of data classification labels for data sets of the one or more participants into one or more clusters of participants. For example, as described above in relation to FIG. 1, clustering component 110 can utilize K-Means clustering to cluster participants based on the label distributions of the data sets of the participants.

At 404, method 400 can comprise selecting, by the system (e.g., selection component 112), participants equitably from across the one or more clusters of participants for a round of federated learning. For example, as described above in relation to FIG. 1, selection component 112 can utilize a round robin process to select participants from across the clusters until a defined number of participants are selected. In an embodiment, selection component 112 can keep track of when a participant is selected to ensure that participants are selected an even number of times across multiple rounds of federated learning. Aggregator 114 can then utilize the selected participants to update the machine learning model.

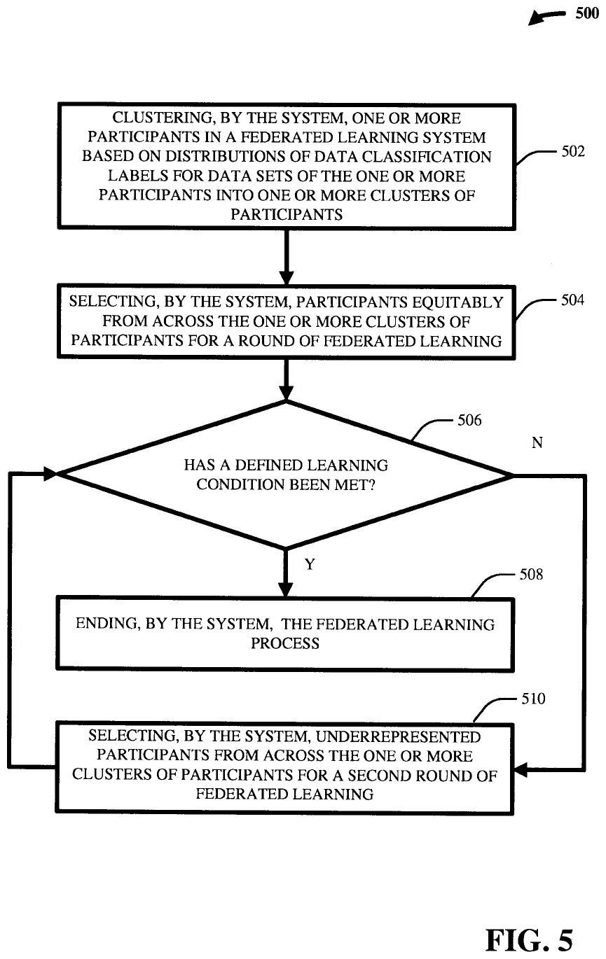

FIG. 5 illustrates a flow diagram of an example, non-limiting computer-implemented method 500 that can facilitate participant selection in accordance with one or more embodiments described herein. Repetitive description of like elements employed in other embodiments described herein is omitted for sake of brevity.

At 502, method 500 can comprise clustering, by a system (e.g., federated learning system 102 and/or clustering component 110) operatively coupled to a processor (e.g., processor 106) one or more participants in a federated learning system based on distributions of data classification labels for data sets of the one or more participants into one or more clusters of participants. For example, as described above in relation to FIG. 1, clustering component 110 can utilize K-Means clustering to cluster participants based on the label distributions of the data sets of the participants.

At 504, method 500 can comprise selecting, by the system (e.g., selection component 112), participants equitably from across the one or more clusters of participants for a round of federated learning. For example, as described above in relation to FIG. 1, selection component 112 can utilize a round robin process to select participants from across the clusters until a defined number of participants are selected. In an embodiment, selection component 112 can keep track of when a participant is selected to ensure that participants are selected an even number of times across multiple rounds of federated learning. Aggregator 114 can then utilize the selected participants to update the machine learning model.

At 506, if a defined learning condition has been met, method 500 can proceed to step 508 and end the federated learning process. If the defined learning condition had not been met, method 500 can proceed to step 510. In an embodiment, the defined learning condition can comprise a condition such as, all participants having been selected at least a defined number of times, a defined number of learning rounds, convergence of the machine learning model, the machine learning model has achieved a defined level of accuracy, a defined elapsed period of training time has been met, and/or another condition utilized to signal that federated learning is complete.

At 510, method 500 can comprise selecting, by the system (e.g., federated learning system 102 and/or selection component 112) underrepresented participants from across the one or more clusters of participants for a second round of federated learning. Method 500 can then return to step 506 to determine if additional rounds of federated learning will take place.

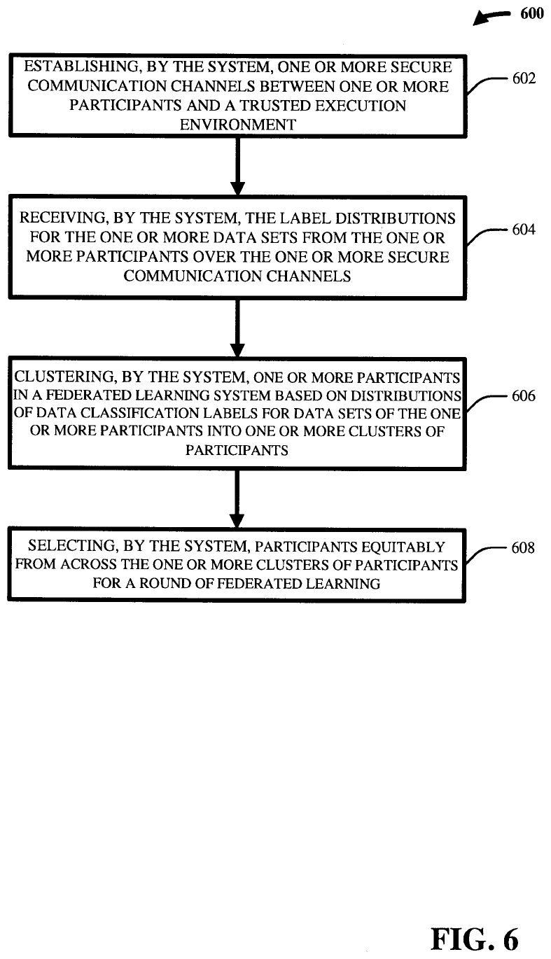

FIG. 6 illustrates a flow diagram of an example, non-limiting computer-implemented method 600 that can facilitate participant selection in accordance with one or more embodiments described herein. Repetitive description of like elements employed in other embodiments described herein is omitted for sake of brevity.

At 602, method 600 can comprise establishing, by a system (e.g., federated learning system 102 and/or communication component 104) secure communication channels between one or more participants and a trusted execution environment. For example, as described above in detail in reference to FIGS. 1 and 2, communication component 104 and/or attestation server 202 can establish secure channels utilizing cryptographic protocols between the participants and a TEE.

At 604, method 600 can comprise receiving, by the system (e.g., federated learning system 102 and/or communication component 104), one or more label distribution for the data sets from the one or more participants over the one or more secure communication channels.

At 606, method 600 can comprise clustering, by the system (e.g., federated learning system 102 and/or clustering component 110), one or more participants in a federated learning system based on distributions of data classification labels for data sets of the one or more participants into one or more clusters of participants. For example, as described above in relation to FIG. 1, clustering component 110 can utilize K-Means clustering to cluster participants based on the label distributions of the data sets of the participants. As described above in reference to FIG. 2, the clustering can be performed within a TEE in order to protect the label distributions and clusters from unauthorized access.

At 608, method 600 can comprise selecting, by the system (e.g., selection component 112), participants equitably from across the one or more clusters of participants for a round of federated learning. For example, as described above in relation to FIG. 1, selection component 112 can utilize a round robin process to select participants from the clusters until a defined number of participants are selected. In an embodiment, selection component 112 can keep track of when a participant is selected to ensure that participants are selected an even number of times across multiple rounds of federated learning. Aggregator 114 can then utilize the selected participants to update the machine learning model. In a further embodiment, selection of the data sets can be performed within a TEE in order to protect the label distributions and clusters from unauthorized access. In various embodiments, once the federated learning is complete, the label distributions and the clusters can be deleted from the TEE and the secure channels can be de-activated in order to better protect sensitive data.

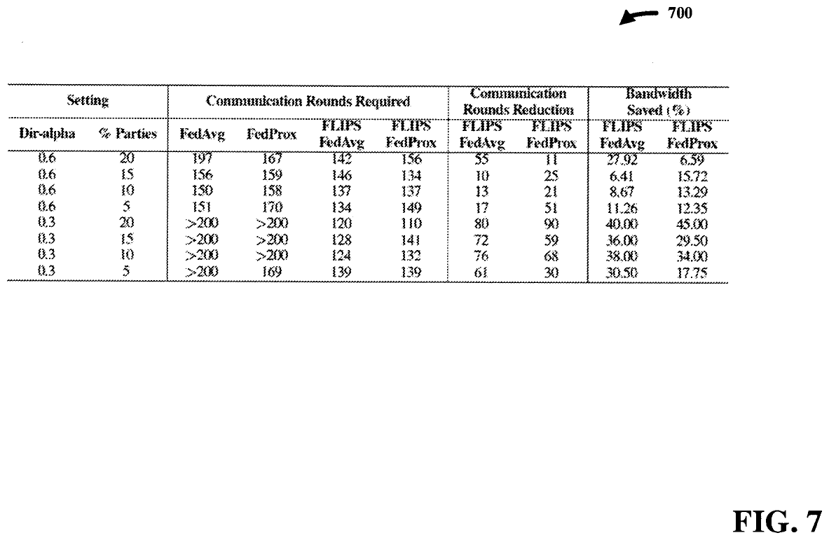

FIG. 7 illustrates a chart 700 comparing the performance of participant selections methods described herein with randomized participant selection in accordance with one or more embodiments described herein. As shown, chart 700 compares experimental results of two methods that utilize random participant selection (e.g., FedAvg and FedProx) and two methods that utilize clustering and participant selection as described herein (e.g., FLIPS FedAvg and FLIPS FedProx) for the FEMNIST dataset. As used herein and in Appendix A, FLIPS stands for Federated Learning with Intelligent Participant Selection. In resource constrained operating environments, non-IID data sets can create bottlenecks, as more learning rounds, and thus more communications rounds, are called for. This creates a strain on network bandwidth, further increasing resource usage for federated learning. As shown, FLIPS FedAvg and FLIPS FedProx methods utilize fewer communication rounds with participants, thereby decreasing the bandwidth utilized to communicate between a federated learning system and the participants. By decreasing utilized bandwidth, the participant selection methods and systems described herein can reduce strain on network resources, thereby improving network performance and decreasing the time used to train the federated learning model.

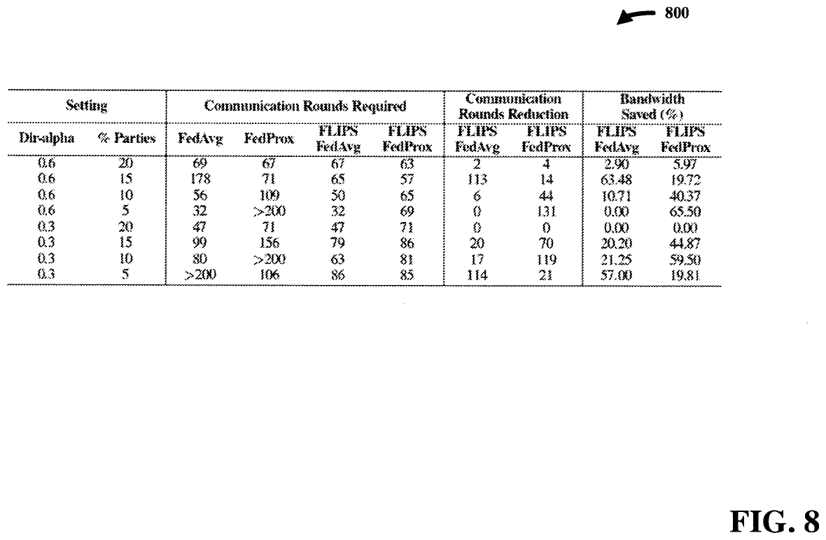

FIG. 8 illustrates a chart 800 comparing the performance of participant selections methods described herein with randomized participant selection in accordance with one or more embodiments described herein. As shown, chart 800 compares experimental results of two methods that utilize random participant selection (e.g., FedAvg and FedProx) and two methods that utilize clustering and participant selection as described herein (e.g., FLIPS FedAvg and FLIPS FedProx) for the Fashion MNST dataset. As shown, FLIPS FedAvg and FLIPS FedProx methods utilize fewer communication rounds with participants, thereby decreasing the bandwidth utilized to communicate between a federated learning system and the participants.

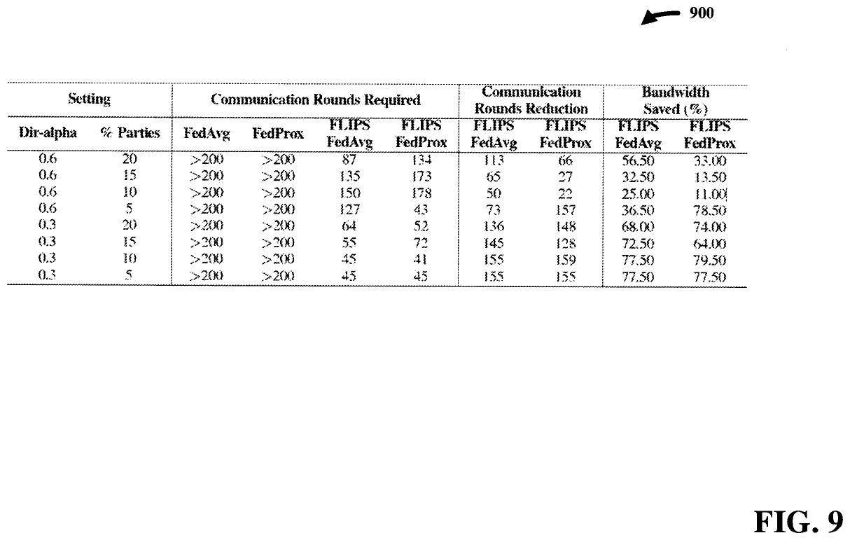

FIG. 9 illustrates a chart 900 comparing the performance of participant selections methods described herein with randomized participant selection in accordance with one or more embodiments described herein. As shown, chart 900 compares experimental results of two methods that utilize random participant selection (e.g., FedAvg and FedProx) and two methods that utilize clustering and participant selection as described herein (e.g., FLIPS FedAvg and FLIPS FedProx) for an EKG dataset. As shown, FLIPS FedAvg and FLIPS FedProx methods utilize fewer communication rounds with participants, thereby decreasing the bandwidth utilized to communicate between a federated learning system and the participants.

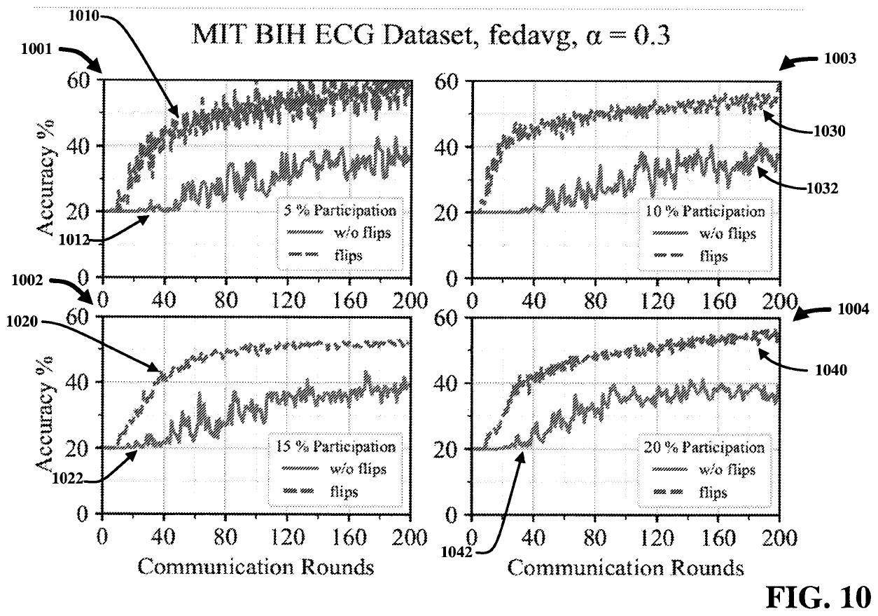

FIG. 10 illustrates graphs comparing the performance of participant selection methods based on clustering as described herein with randomized participant selection methods in accordance with one or more embodiments described herein.

Graphs 1001, 1002, 1003 and 1004 compare the performance of participant selection methods as described herein with randomized participant selection methods (FedAvg) utilizing a data set with a partition parameter of 0.3. The x-axis of graphs 1001, 1002, 1003 and 1004 show the number of communication rounds utilized, and the y-axis of graphs 1001, 1002, 1003 and 1004 show the accuracy of the machine learning model produced via federated learning. Graph 1001 shows the results of selecting 5% of total participants per round of training, graph 1002 shows the results of selecting 15% of total participants per round of training, graph 1003 shows the results of selecting 10% of total participants per round of training, and graph 1004 shows the results of selecting 20% of the total participants per round of training. Lines 1010, 1020, 1030 and 1040 show the performance of utilizing participant selection methods based on clustering as described herein (e.g., FLIPS) and lines 1012, 1022, 1032 and 1042 show the performance of randomized participant selection methods (FedAvg). As shown, the participant selection methods described herein (FLIPS) enable greater accuracy for aggregators with fewer rounds of training in comparison to methods utilizing randomized participant selection, thereby both improving convergence and performance of the machine learning model and decreasing the network resources utilized in federated learning.

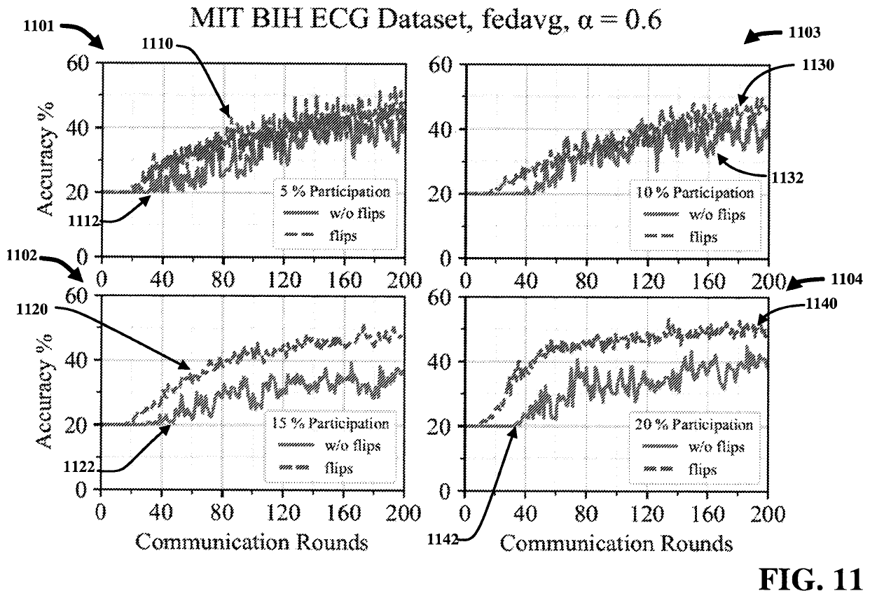

FIG. 11 illustrates graphs comparing the performance of participant selection methods based on clustering as described herein with randomized participant selection methods in accordance with one or more embodiments described herein.

Graphs 1101, 1102, 1103 and 1104 compare the performance of participant selection methods as described herein with randomized participant selection methods (FedAvg) utilizing a data set with a partition parameter of 0.6. The x-axis of graphs 1101, 1102, 1103 and 1104 show the number of communication rounds utilized, and the y-axis of graphs 1101, 1102, 1103 and 1104 show the accuracy of an aggregator. Graph 1101 shows the results of selecting 5% of total participants per round of training, graph 1102 shows the results of selecting 15% of total participants per round of training, graph 1103 shows the results of selecting 10% of total participants per round of training, and graph 1104 shows the results of selecting 20% of the total participants per round of training. Lines 1110, 1120, 1130 and 1140 show the performance of utilizing participant selection methods based on clustering as described herein (e.g., FLIPS) and lines 1112, 1122, 1132 and 1142 show the performance of randomized participant selection methods (FedAvg). As shown, the participant selection methods described herein (FLIPS) enable greater accuracy for aggregators with fewer rounds of training in comparison to methods utilizing randomized participant selection, thereby both improving convergence and performance of the machine learning model and decreasing the network resources utilized in federated learning.

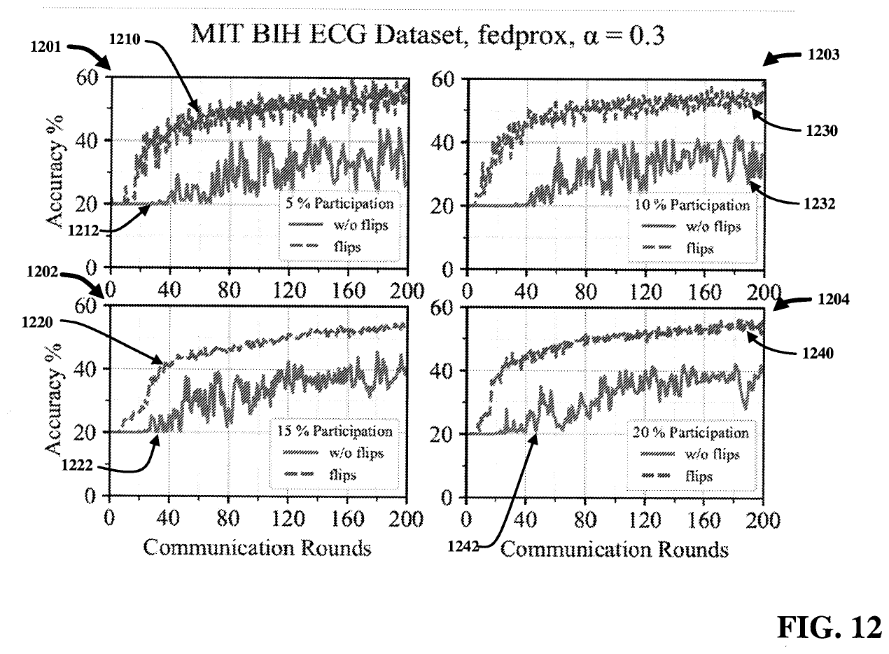

FIG. 12 illustrates graphs comparing the performance of participant selection methods based on clustering as described herein with randomized participant selection methods in accordance with one or more embodiments described herein.

Graphs 1201, 1202, 1203 and 1204 compare the performance of participant selection methods as described herein with randomized participant selection methods (FedProx) utilizing a data set with a partition parameter of 0.3. The x-axis of graphs 1201, 1202, 1203 and 1204 show the number of communication rounds utilized, and the y-axis of graphs 1201, 1202, 1203 and 1204 show the accuracy of an aggregator. Graph 1201 shows the results of selecting 5% of total participants per round of training, graph 1202 shows the results of selecting 15% of total participants per round of training, graph 1203 shows the results of selecting 10% of total participants per round of training, and graph 1204 shows the results of selecting 20% of the total participants per round of training. Lines 1210, 1220, 1230 and 1240 show the performance of utilizing participant selection clustering methods as described herein (e.g., FLIPS) and lines 1212, 1222, 1232 and 1242 show the performance of randomized participant selection methods (FedProx). As shown, the participant selection methods described herein (FLIPS) enable greater accuracy for aggregators with fewer rounds of training in comparison to methods utilizing randomized participant selection, thereby both improving convergence and performance of the machine learning model and decreasing the network resources utilized in federated learning.

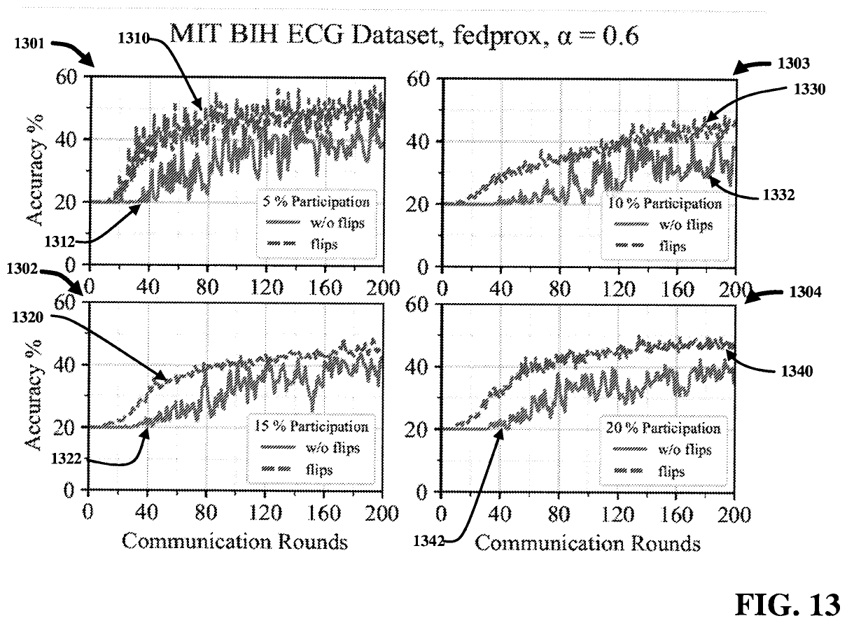

FIG. 13 illustrates graphs comparing the performance of participant selection methods based on clustering as described herein with randomized participant selection methods in accordance with one or more embodiments described herein.

Graphs 1301, 1302, 1303 and 1304 compare the performance of participant selection methods as described herein with randomized participant selection methods (FedProx) utilizing a data set with a partition parameter of 0.6. The x-axis of graphs 1301, 1302, 1303 and 1304 show the number of communication rounds utilized, and the y-axis of graphs 1301, 1302, 1303 and 1304 show the accuracy of an aggregator. Graph 1301 shows the results of selecting 5% of total participants per round of training, graph 1302 shows the results of selecting 15% of total participants per round of training, graph 1303 shows the results of selecting 10% of total participants per round of training, and graph 1304 shows the results of selecting 20% of the total participants per round of training. Lines 1310, 1320, 1330 and 1340 show the performance of utilizing participant selection methods based on clustering as described herein (e.g., FLIPS) and lines 1312, 1322, 1332 and 1342 show the performance of randomized participant selection methods (FedProx). As shown, the participant selection methods described herein (FLIPS) enable greater accuracy for aggregators with fewer rounds of training in comparison to methods utilizing randomized participant selection, thereby both improving convergence and performance of the machine learning model and decreasing the network resources utilized in federated learning.

Federated learning system 102 can provide technological improvements to systems, devices, components, operation steps, and/or processing steps associated with participant selection in federated learning. For example, by clustering participants based on distribution labels and selecting data sets evenly from clusters, federated learning system 102 can generated better balanced sets of participants per round of federated learning, allowing for more accurate representation of participant data as a whole during federated learning.

Federated learning system 102 can provide technical improvements to a processing unit associated with federated learning system 102. For example, by clustering participants based on distribution labels and selecting participants evenly from clusters, the amount of communication called for between the aggregator 114 and the participants 116 is reduced, thereby reducing the workload of a processing unit (e.g., processor 106) that is employed to execute routines (e.g., instructions and/or processing threads) involved federated learning. In this example, by reducing the workload of such a processing unit (e.g., processor 106), federated learning system 102 can thereby facilitate improved performance, improved efficiency, and/or reduced computational cost associated with such a processing unit. Further, by decreasing the amount of communication between the participants and aggregator 114, federated learning system 102 decreases the amount of data transmitted between participants 116 and aggregator 114 during federated learning, thereby decreasing network traffic and improving network speed, enabling federated learning system 102 to operate over networks with reduced bandwidth.

A practical application of federated learning system 102 is that it allows for federated learning utilizing a reduced amount of computing and/or network resources, in comparison to other methods, thereby decreasing the costs associated with systems that can perform federated learning.

It is to be appreciated that federated learning system 102 can utilize various combination of electrical components, mechanical components, and circuitry that cannot be replicated in the mind of a human or performed by a human as the various operations that can be executed by federated learning system 102 and/or components thereof as described herein are operations that are greater than the capability of a human mind. For instance, the amount of data processed, the speed of processing such data, or the types of data processed by federated learning system 102 over a certain period of time can be greater, faster, or different than the amount, speed, or data type that can be processed by a human mind over the same period of time. According to several embodiments, federated learning system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that federated learning system 102 can include information that is impossible to obtain manually by an entity, such as a human user. For example, the type, amount, and/or variety of information included in federated learning system 102 can be more complex than information obtained manually by an entity, such as a human user.

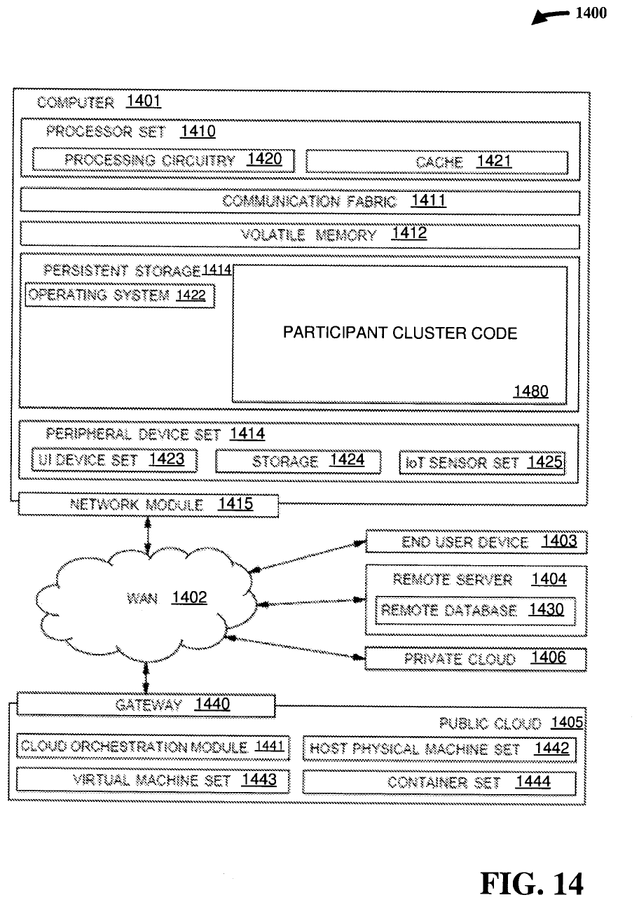

FIG. 14 and the following discussion are intended to provide a brief, general description of a suitable computing environment 1400 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as translation of an original source code based on a configuration of a target system by the participant cluster code 1480. In addition to block 1480, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1480, as identified above), peripheral device set 1414 (including user interface (UI), device set 1423, storage 1424, and Internet of Things (IoT) sensor set 1425), and network module 1414. Remote server 1404 includes remote database 1430. Public cloud 1405 includes gateway 1440, cloud orchestration module 1441, host physical machine set 1442, virtual machine set 1443, and container set 1444.

COMPUTER 1401 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method can be distributed among multiple computers and/or between multiple locations. On the other hand, in this presentation of computing environment 1400, detailed discussion is focused on a single computer, specifically computer 1401, to keep the presentation as simple as possible. Computer 1401 can be located in a cloud, even though it is not shown in a cloud in FIG. 14. On the other hand, computer 1401 is not required to be in a cloud except to any extent as can be affirmatively indicated.

PROCESSOR SET 1410 includes one, or more, computer processors of any type now known or to be developed in the future. Processing circuitry 1420 can be distributed over multiple packages, for example, multiple, coordinated integrated circuit chips. Processing circuitry 1420 can implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set can be located “off chip.” In some computing environments, processor set 1410 can be designed for working with qubits and performing quantum computing.

Computer readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1421 and the other storage media discussed below. The program instructions, and associated data, are accessed by processor set 1410 to control and direct performance of the inventive methods. In computing environment 1400, at least some of the instructions for performing the inventive methods can be stored in block 1480 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, the volatile memory is characterized by random access, but this is not required unless affirmatively indicated. In computer 1401, the volatile memory 1412 is located in a single package and is internal to computer 1401, but, alternatively or additionally, the volatile memory can be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 can be a read only memory (ROM), but typically at least a portion of the persistent storage allows writing of data, deletion of data and re-writing of data. Some familiar forms of persistent storage include magnetic disks and solid-state storage devices. Operating system 1422 can take several forms, such as various known proprietary operating systems or open-source Portable Operating System Interface type operating systems that employ a kernel. The code included in block 1480 typically includes at least some of the computer code involved in performing the inventive methods.

PERIPHERAL DEVICE SET 1414 includes the set of peripheral devices of computer 1401. Data communication connections between the peripheral devices and the other components of computer 1401 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1423 can include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 can be persistent and/or volatile. In some embodiments, storage 1424 can take the form of a quantum computing storage device for storing data in the form of qubits. In embodiments where computer 1401 is required to have a large amount of storage (for example, where computer 1401 locally stores and manages a large database) then this storage can be provided by peripheral storage devices designed for storing large amounts of data, such as a storage area network (SAN) that is shared by multiple, geographically distributed computers. IoT sensor set 1425 is made up of sensors that can be used in Internet of Things applications. For example, one sensor can be a thermometer and another sensor can be a motion detector.

NETWORK MODULE 1414 is the collection of computer software, hardware, and firmware that allows computer 1401 to communicate with other computers through WAN 1402. Network module 1414 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1414 are performed on the same physical hardware device. In other embodiments (for example, embodiments that utilize software-defined networking (SDN)), the control functions and the forwarding functions of network module 1414 are performed on physically separate devices, such that the control functions manage several different network hardware devices. Computer readable program instructions for performing the inventive methods can typically be downloaded to computer 1401 from an external computer or external storage device through a network adapter card or network interface included in network module 1414.

WAN 1402 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401) and can take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1414 of computer 1401 through WAN 1402 to EUD 1403. In this way, EUD 1403 can display, or otherwise present, the recommendation to an end user. In some embodiments, EUD 1403 can be a client device, such as thin client, heavy client, mainframe computer and/or desktop computer.

REMOTE SERVER 1404 is any computer system that serves at least some data and/or functionality to computer 1401. Remote server 1404 can be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data can be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs can be stored as images and can be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware and firmware allowing public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

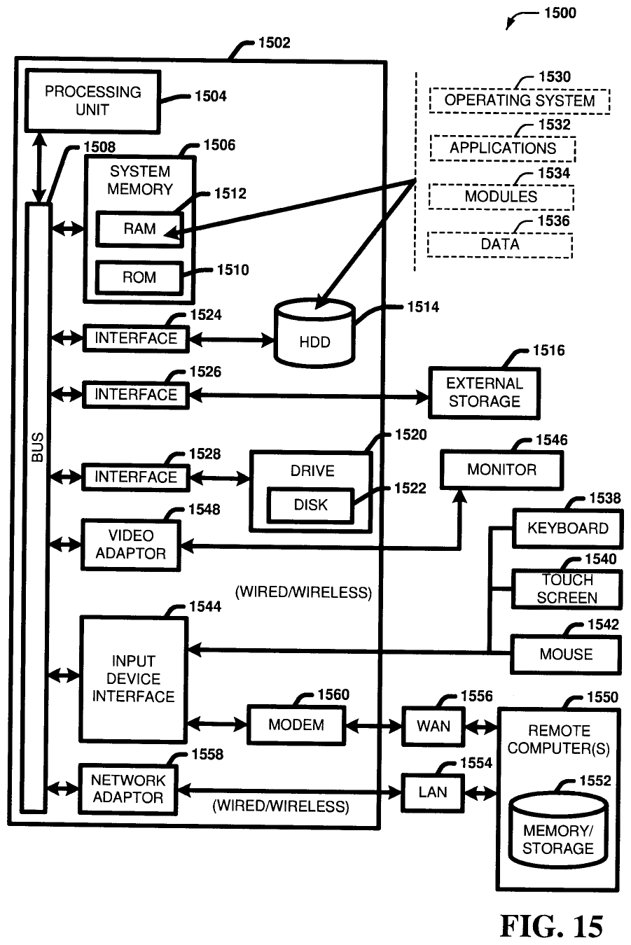

In order to provide a context for the various aspects of the disclosed subject matter, FIG. 15 as well as the following discussion are intended to provide a general description of a suitable environment in which the various aspects of the disclosed subject matter can be implemented. FIG. 15 illustrates a block diagram of an example, non-limiting operating environment in which one or more embodiments described herein can be facilitated. Repetitive description of like elements employed in other embodiments described herein is omitted for sake of brevity.

With reference to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and a drive 1520, e.g., such as a solid state drive, an optical disk drive, which can read or write from a disk 1522, such as a CD-ROM disc, a DVD, a BD, etc. Alternatively, where a solid state drive is involved, disk 1522 would not be included, unless separate. While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and drive 1520 can be connected to the system bus 1508 by an HDD interface 1524, an external storage interface 1526 and a drive interface 1528, respectively. The interface 1524 for external drive implementations can include at least one or both of Universal Serial Bus (USB) and Institute of Electrical and Electronics Engineers (IEEE) 1594 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enable with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1594 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above, such as but not limited to a network virtual machine providing one or more aspects of storage or processing of information. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components; and
a processor, operatively coupled to the memory, that executes the computer executable components stored in the memory, wherein the computer executable components comprise:
a clustering component that clusters one or more participants in a federated learning system based on distributions of data classification labels for data sets of the one or more participants into one or more clusters of participants; and
a selection component that selects participants equitably from across the one or more clusters of participants for a round of federated learning.

2. The system of claim 1, wherein the computer executable components further comprise:
a communication component that establishes one or more secure communication channels between the one or more participants and a trusted execution environment.

3. The system of claim 2, wherein the communication component further receives the distributions of data classification labels for the data sets from the one or more participants over the one or more secure communication channels.

4. The system of claim 2, wherein the clustering component operates within the trusted execution environment.

5. The system of claim 2, wherein the distributions of data classification labels for the data sets are stored in the trusted execution environment.

6. The system of claim 1, wherein the selection component further:
selects underrepresented participants from across the one or more clusters of participants for a second round of federated learning.

7. A computer-implemented method comprising:
clustering, by a system operatively coupled to a processor, one or more participants in a federated learning system based on distributions of data classification labels for data sets of the one or more participants into one or more clusters of participants; and
selecting, by the system, participants equitably from across the one or more clusters of participants for a round of federated learning.

8. The computer-implemented method of claim 7, further comprising, establishing, by the system, one or more secure communication channels between the one or more participants and a trusted execution environment.

9. The computer-implemented method of claim 8, further comprising:
receiving, by the system, the one or more the distributions of data classification labels for the data sets from the one or more participants over the one or more secure communication channels.

10. The computer-implemented method of claim 8, wherein the clustering the one or more participants based on the distributions of data classification labels is performed within the trusted execution environment.

11. The computer-implemented method of claim 8, wherein the distributions of data classification labels for the data sets are stored in the trusted execution environment.

12. The computer-implemented method of claim 7, further comprising:
selecting, by the system, underrepresented participants from across the one or more clusters of participants for a second round of federated learning.

13. The computer-implemented method of claim 7, wherein the clustering comprises K-means clustering.

14. A computer program product comprising a computer readable storage medium having program instructions embodied therewith, the program instructions executable by a processor to cause the processor to:
cluster one or more participants in a federated learning system based on distributions of data classification labels for data sets of the one or more participants into one or more clusters of participants; and
select participants equitably from across the one or more clusters of participants for a round of federated learning.

15. The computer program product of claim 14, wherein the program instructions further cause the processor to:
establish one or more secure communication channels between the one or more participants and a trusted execution environment.

16. The computer program product of claim 15, wherein the program instructions further cause the processor to:
receive the one or more the distributions of data classification labels for the data sets from the one or more participants over the one or more secure communication channels.

17. The computer program product of claim 15, wherein the clustering the participants based on the distributions of data classification labels is performed within the trusted execution environment.

18. The computer program product of claim 15, wherein the distributions of data classification labels for the data sets are stored in the trusted execution environment.

19. The computer program product of claim 14, wherein the program instructions further cause the processor to:
select underrepresented participants from across the one or more clusters of participants for a second round of federated learning.

20. The computer program product of claim 14, wherein the clustering comprises K-means clustering.
